(19) United States
(12) Patent Application Publication
(10) Pub. No.: US 2009/0044355 A1
(43) Pub. Date: Feb. 19, 2009

(54) Field service worker/meter reader dog defense stick and lid access tool

(76) Inventor: Jaime Orozco, Downey, CA (US)

Correspondence Address: ZUBER & TAILLIEU LLP, 10866 WILSHIRE BLVD., SUITE 300, LOS ANGELES, CA, 90024, US

(21) Appl. No.: 11/893,566

(22) Filed: Aug. 15, 2007

(51) Int. Cl. A46B 15/00; B25B 33/00; G02B 7/18

(52) U.S. Cl. 15/105; 359/840; 359/882; 81/488

(57) ABSTRACT

A multi-functional curb meter reading/defense stick tool having a lightweight construction for use by field workers/meter readers. It includes a central rod shaped body having a first handle end capable of housing a small bottle of water or other liquid. The central rod shaped body further includes a distal end having a locking mechanism which includes a “J” shaped latch and a compression spring/pressure point. The rod shaped body and locking mechanism are designed to allow various functional devices to be coupled to the distal end of the rod, such as a mirror device, a hook/latch and/or an end magnet. These various devices can be used to gain access to and more easily read metering devices which may be positioned behind a locked gate or fenced in area.

### FIELD OF THE INVENTION

This invention relates generally to devices/apparatus for use by field workers/meter readers. More specifically, the invention relates to a multi-functional utility meter reading/defense stick device which can be used by field workers/meter readers.

### BACKGROUND OF THE INVENTION

Field workers/meter readers must normally travel from house to house within a wide geographic area and read localized meters which may stationed curbside directly adjacent and/or coupled to a house or home. Often these workers may encounter locked gates or fences, behind which set localized meters may be located, making it difficult—if not altogether impossible—for the field worker/meter reader to obtain an accurate meter reading.

Additionally, these field workers/meter readers may also encounter dogs or other animals along the way, and these animals may pose an immediate threat or danger to the field worker/meter reader, thereby inhibiting the ability of the field worker/meter reader to fully perform his or her duties.

In view of the limitations now present in the prior art, what is needed is a new and useful curb meter reading tool and dog defense stick device having a simple, lightweight construction, versatility, and multi-functional operations. More specifically, what is needed is a new and improved curb meter reading tool and dog defense stick device which can be used to repel dogs and/or other threatening animals and which can also assist the field worker/meter reader in performing his or her duties and functions in obtaining access to and reading the localized meters.

### OBJECTS OF THE INVENTION

A principal object of the present invention is to provide a safer and faster way to access customer utility meters in that the meter reading tool and dog defense stick device will overcome the deficiencies of the prior art devices by enabling field workers/meter readers to gain visibility access to localized utility meters.

Another object of the present invention is to provide an increased distance between field personnel and hazardous conditions that exist out in the field. This distance can be obtained through the use of a mirror attachment which is included as a feature of the present invention, thereby allowing individuals to look over gates, walls or partitions before entering into customers' properties. The mirror attachment also allows field personnel to avoid entering customers' properties altogether such that they might view a meter dial index from over, under or around a wall, gate or partition. Increasing the safety provided to the individual field worker/meter reader.

Another object of the present invention is to provide a defense against hazardous animals such as dogs. The invention includes a recess for housing a spray bottle of repellent spray or other liquid which can be used to spray dogs, or other dangerous animals, in an effort to halt an oncoming attack.

Another object of the invention is to provide increased visibility of meters which may be dirty. Accordingly, the invention includes a cleaning sponge ball positioned circumferentially around the invention which is used in conjunction with a spray bottle of water and/or cleaning fluid (instead of repellant), that can be carried in a recess within the handle of the invention, as described further hereinafter. The spray bottle of water and/or cleaning fluid can be used to spray the dial glass on a meter, and the cleaning ball is then used to wipe clean the dial glass for better visibility when trying to read the meter dial index.

Another object of the present invention is to provide a faster and easier access to the curb meter lid in an effort to obtain a curb meter index read. Accordingly, the invention includes a removeably attachable grate hook which can be coupled to a distal end of the device and used to easily lift/open the meter lid, allowing access to the meter index. This expedites the process in the effort of obtaining the meter dial index read while maintaining a safer distance and minimizing the risk/danger inherent in having to enter the premises and lift the lid manually.

Another object of the present invention is to provide a faster and easier access to the curb meter lid in an effort to obtain a curb meter index read. Accordingly, the invention includes a removeably attachable end magnet which can be coupled to the distal end of the device and used to magnetize a meter lid, thereby allowing easy lift of the lid to access the meter index. This expedites the process in the effort of obtaining the meter dial index read while maintaining a safer distance and minimizing the risk/danger inherent in having to enter the premises and lift the lid manually.

Another object of the present invention is to provide a chew ball for dogs and/or other dangerous animals, which may used by the field worker/meter reader incase the dog or animal gets close enough to attack and bite. Dogs are encouraged to bite on the chew ball because it is made of rawhide, which is neither too hard nor too soft for their teeth. With a satisfied bite, dogs will continue to bite on the chew ball rather than the persons—i.e. the field worker/meter reader—defending themselves.

It is intended that any other advantages and objects of the present invention that become apparent or obvious from the detailed description or illustrations contained herein are within the scope of the present invention.

### SUMMARY OF THE INVENTION

The invention is directed toward and comprises a multi-functional curb meter reading/defense stick tool having a lightweight construction for use by field workers/meter readers. It includes a central rod shaped body having a first open (handle) end capable of housing any one of several items including a flashlight, a small spray bottle which may be filled with repellant (such as pepper spray), soapy or non-soapy H₂O, oil, or just about any other liquid substance. In a preferred embodiment, a handled end of the device is open and includes an inner lining material made preferably of foam or rubber, which provides circumferential resilience and friction against the small spray bottle when inserted into the handle end of the device.

The distal end of the central rod shaped body preferably forms in a second end alo having an open surface such that additional items may be coupled within/to the device at the distal end. More specifically, the distal end includes a locking mechanism for removeably coupling various end pieces to the distal end, said locking mechanism including a compression spring and pressure point with a “J” shaped catch on one side of the outer surface of the device at the distal end. The locking mechanism allows any one of several interchangeable end pieces to be coupled to the distal end. These interchangeable end pieces include a mirror device, a hook/latch device, and/or an end magnet.

The invention further includes a foam/sponge ball positioned circumferentially around the distal end of the central rod/body which serves as a distraction for dogs/animals to bite onto in order to fend off any oncoming attack. More specifically, a foam/sponge ball is positioned at the distal end of the central rod, preferably flush with the same, and is used to ward off any incoming animals such as dogs. The foam/sponge ball may also be used to clean glass and/or other surfaces of meters when the device is in use. In one embodiment, the foam/sponge ball may house/surround a smaller cylindrical rawhide ball, also disposed circumferentially about the distal end of the central rod shaped body in order to provide support to the sponge ball.

As explained earlier hereinabove, the invention further includes several removable/attachable end pieces which may be interlocked at the distal end of the central rod shaped body including an attachable mirror, a hook/latch, and/or an end magnet, either of which may be selectively and interchangeably coupled to the substantially flat distal end of said central rod shaped body. In a preferred embodiment, the double-sided mirror preferably has a first flat surface and a second convex surface and can be used to read metering devices which may be positioned behind a locked gate or fenced in area. The hook/latch can be used to grasp a lid of a meter and lift it from a distance which may also be positioned behind a locked fence or gate. The end magnet can be used to magnetize and lift a metal lid/cover on a meter in order to facilitate reading of the meter from a safe distance.

### DESCRIPTION OF THE DRAWINGS

The following drawing further describes by illustrations of the advantages and objects of the present invention. The drawing is in reference by corresponding figure reference characters:

FIG. 1 illustrates a perspective view of a preferred embodiment of the present invention;

FIG. 2 illustrates a close-up view of the opening or cavity in the handle end of the device of the present invention;

FIG. 3 illustrates a close-up view of the distal end of a preferred embodiment of the present invention;

FIG. 4 shows a close-up cross-sectional view of the locking mechanism at the distal end of the central rod shaped body of the present invention;

FIG. 5 illustrates a removeably attachable mirror device for use with the present invention;

FIG. 6 illustrates a close-up break-out view of the removeably attachable mirror device when attached to the distal end of the present invention;

FIG. 7 illustrates a perspective view of the present invention when the mirror device is attached to the distal end;

FIG. 8 illustrates an alternate mirror device for use with the present invention, wherein the mirror is double sided and includes a telescoping base;

FIG. 9 illustrates a removeably attachable hook/latch device for use with the present invention;

FIG. 10 illustrates a close-up break-out view of the hook/latch device when attached to the distal end of the present invention;

FIG. 11 illustrates a close up-perspective view of the distal end of the present invention when the end magnet is attached to the distal end;

FIG. 12 illustrates a close-up cross-sectional view of the distal end of the present invention when the end magnet is attached to the distal end.

### DETAILED DESCRIPTIONS OF PREFERRED EMBODIMENTS

The present invention is directed toward a new and useful meter reading tool and dog defense stick device (hereinafter “meter tool”) having a simple, lightweight construction, versatility, and multi-functional operations, which can be used to repel dogs and/or other threatening animals and which can also assist a field worker/meter reader in performing his or her duties.

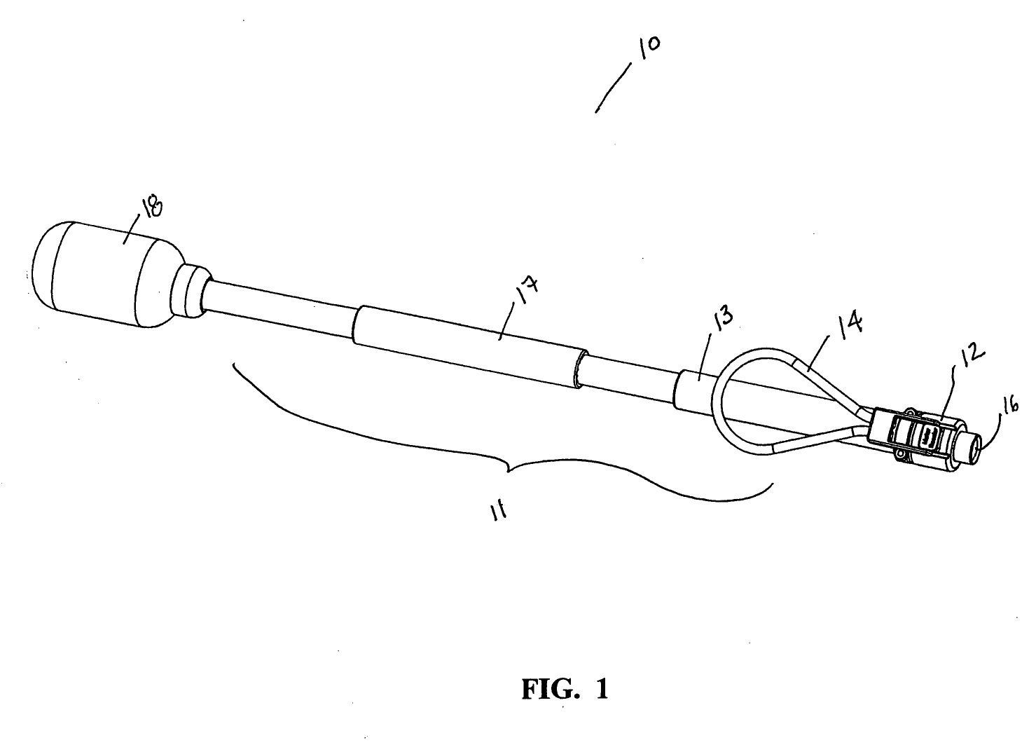

FIG. 1 illustrates a first preferred embodiment of the Curb Meter Tool 10 of the present invention. As shown in FIG. 1, the device is comprised of a central rod shaped body 11 which is preferably made from a 2.5 to 3 foot lightweight metal or fiberglass pipe or rod. The body 11 is designed to measure approximately thirty (30) inches in length but can be modified to be longer or shorter depending on the individual needs. More specifically, it is preferably designed to be long enough to provide protection from hazards such as dogs by utilizing the tool to acquire space between the dog and the individual if/when a dog(s) attacks, as well as to deliver an extended amount of visibility when looking over, around and under gates, walls or partitions with the length of the pipe added to the individuals arm length. However, the body 11 is designed not to be too long, in order to avoid dragging on the ground when walking from meter reading site to site.

The central rod shaped body 11 is preferably 1-inch in width and having a hollow interior, with sufficient thickness to provide a sturdy, firm body which will not easily bend or break. It is understood that the central rod shaped body 11 may be comprised of other materials such as wood and/or plastic and is not intended to be limited in composition but is designed to be fairly lightweight and easy to carry.

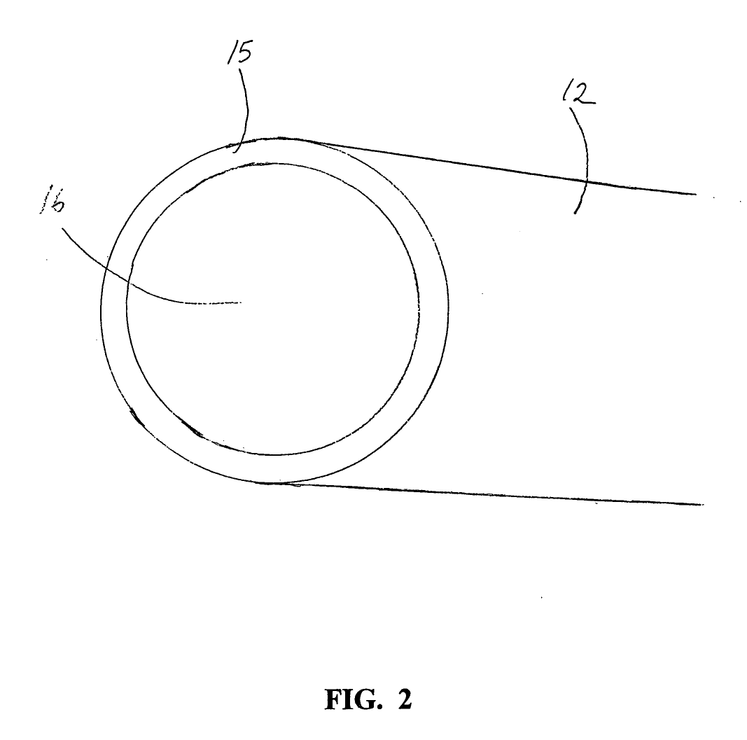

In a preferred embodiment, the central rod shaped body is preferably includes a first, handle end which is open at the top, thereby forming a cavity or housing at the end of said rod. FIG. 2 illustrates a close up view of the handle end of the device, in order to better illustrate the cavity or housing. In a preferred embodiment, the cavity or housing is capable of housing any one of several items including a flashlight and/or a small spray bottle, which may be filled with repellant (such as pepper spray), soapy or non-soapy H₂O, oil, or just about any other liquid substance. As further shown in FIG. 2, the opening or cavity in the handle end of the device preferably includes an inner lining material 15 made preferably of flexible foam or resilient rubber, which provides circumferential resilience and friction against a flashlight or small spray bottle when it is inserted into the handle end of the device, thereby retaining and holding it within the cavity at the handle end.

In a preferred embodiment, a steel cast 12 is preferably added circumferentially around the rod, at said first end of the central rod shaped body for added support and protection. Referring again to FIG. 1, the meter tool of the present invention further includes a handgrip 13 disposed around the rod and adjacent to the first end of said central rod shaped body 11. The handgrip 13 is preferably made of hard rubber. In a preferred embodiment, the meter tool of the present invention further includes a leather strap 14 which moveably coupled and/or attached to the device for more comfort and support. The strap 14 is preferably long enough so that a user may place his/her wrist through the strap when gripping the handgrip 13. It is preferably made of leather, for comfort and durability, and is designed to keep the tool from dropping to the ground if the grip is lost.

Referring again to FIG. 1, an additional rubber grip 17 is positioned circumferentially around the rod at the center of the rod, in order to provide further lifting support with a second hand when lifting the meter tool of the present invention. Accordingly, using on one hand on the handgrip 13 and one on the additional rubber grip 17, an individual can raise the rod shaped body 11 upward in order to lift it over a fence, gate, or retaining wall or in order to ward off any oncoming dogs or other animals.

As is further illustrated in FIG. 1, a cleaning ball 18 is positioned circumferentially about the central rod shaped body 11, at the distal and opposite end of the central rod shaped body. The cleaning ball 18 is preferably made of sponge-like material and may be used to clean the dial glass and/or other parts of meters when trying to read the dial index. In an alternate embodiment, a cylindrical rawhide ball is disposed circumferentially about the central rod shaped body, within the cleaning sponge ball 18 in order to provide support to the sponge ball. The cylindrical rawhide ball provides further support to the foam/sponge ball and further encourages dogs to bite on the sponge rather than attacking the person holding the tool.

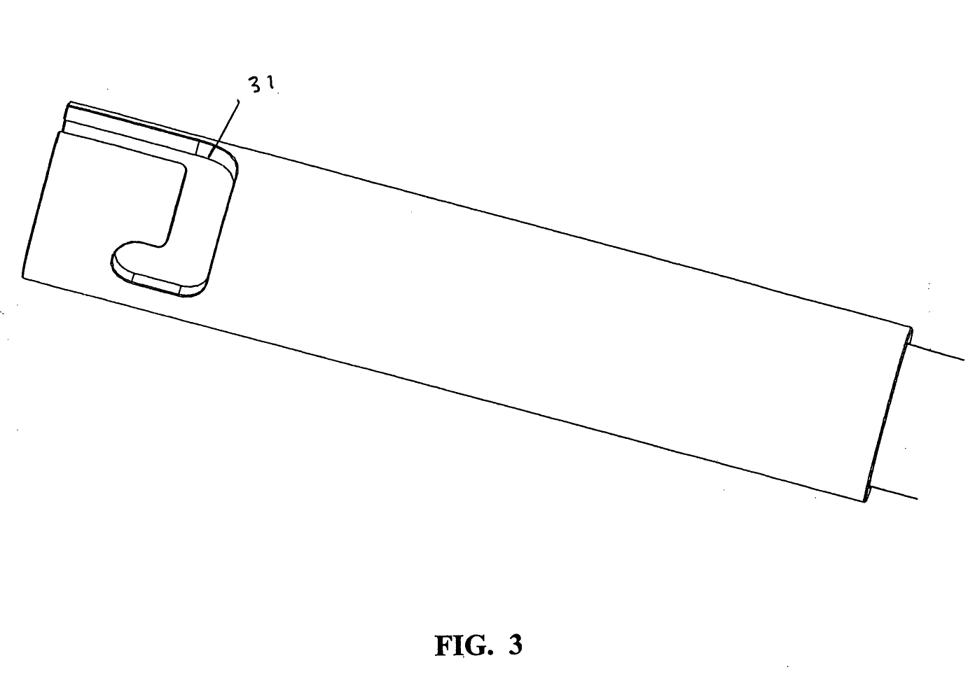

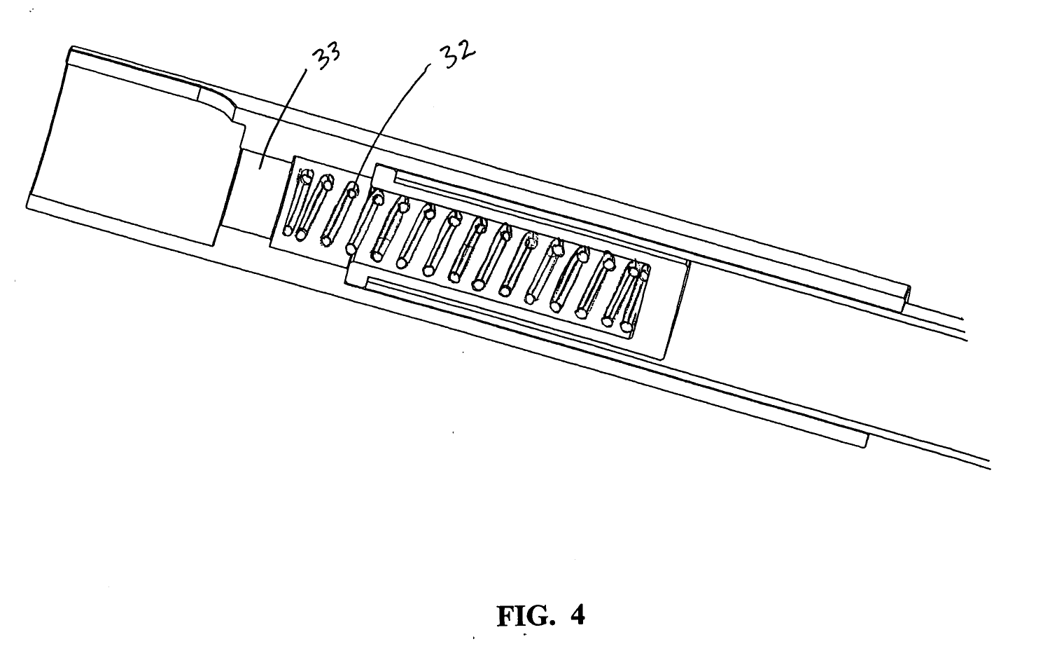

Since the central rod shaped body is preferably hollow, the distal end of the device also has an opening. However, unlike the handle end, the distal end is not lined on the interior, instead, the distal end preferably includes a locking mechanism for selectively and removeably attaching any one of several devices to the end of the rod. FIG. 3 illustrates a close-up view of the distal end of a preferred embodiment of the present invention, while FIG. 4 shows a close-up cross-sectional view of the locking mechanism at the distal end of the central rod shaped body. It is understood that the locking mechanism is actually integral to the central rod shaped body, at the distal end of the rod, just below the sponge ball when it is placed at the distal end, so that when the sponge ball is placed at the distal end the locking mechanism is not visible from the outside. Accordingly, the sponge ball has been removed from FIGS. 3 and 4 in order to show just the rod and the locking mechanism.

As is shown in these figures, the locking mechanism includes a “J” shaped catch 31 in the outer surface of the distal end, which will be used to restrain a locking bump on the side of any one of the interchangeable items/devices when they are coupled to the distal end of the rod. Inside (see FIG. 4), the distal end of the rod includes a compression spring 32 and pressure point 33 which is used to lock any one of the devices into place (a mirror, a latch/hook, and/or an end magnet). Preferably, the compression spring 32 and pressure point 33 exert outward pressure on any of the devices when engaged with the “J” shaped catch 31, thereby firmly locking the device into place.

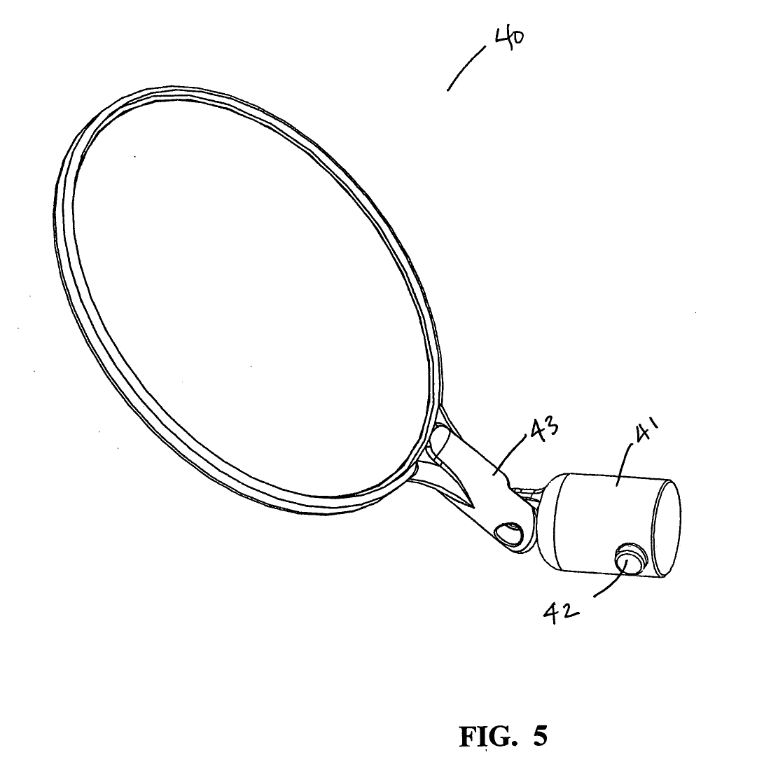

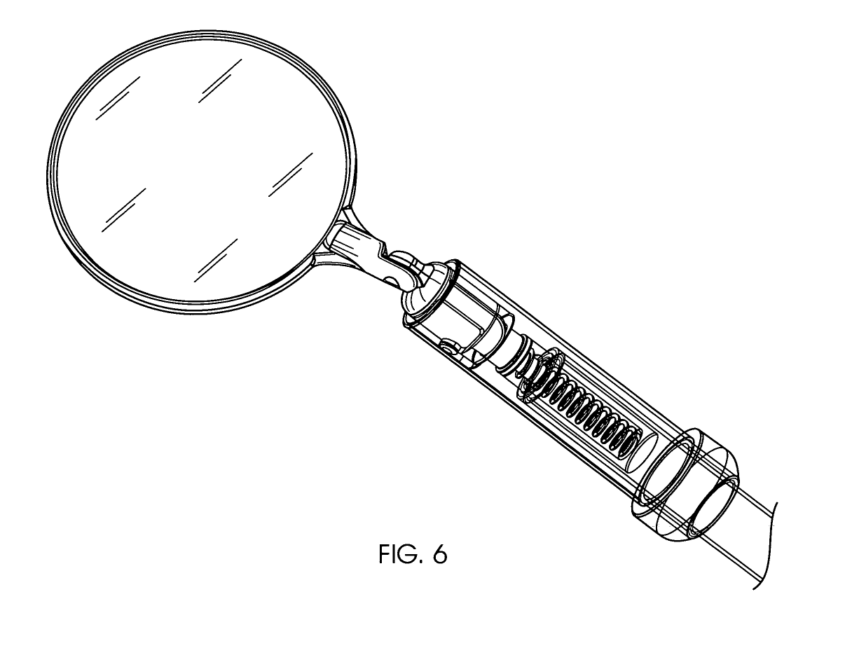

In a preferred embodiment, a mirror device may be removeably coupled to the distal end of the rod. FIG. 5 illustrates a removeably attachable mirror device 40 for use with the present invention; while FIG. 6 illustrates a close-up break-out view of a removeably attachable mirror device when attached to the distal end of the present invention. As shown in these two figures, the mirror device 40 includes a base 41 having a locking bump 42 positioned on one side. When the base 41 is inserted into the distal end of the rod, the locking bump 42 is placed into the “J” shaped catch 31. The compression spring 32 and pressure point 33 force the base 41 outward, securing the locking bump 42 within the “J” shaped catch 31. The mirror device 40 can be attached to the distal end of the rod in order to provide individuals with more visibility when trying to look over, under and around gates, walls and partitions. When the mirror device is attached to the tool, individuals can use the body length, along with their arm's reach, to get better visibility while maintaining a safer distance from hazardous conditions when they are trying to gain access into a property or when trying to read a meter dial index according to the present invention.

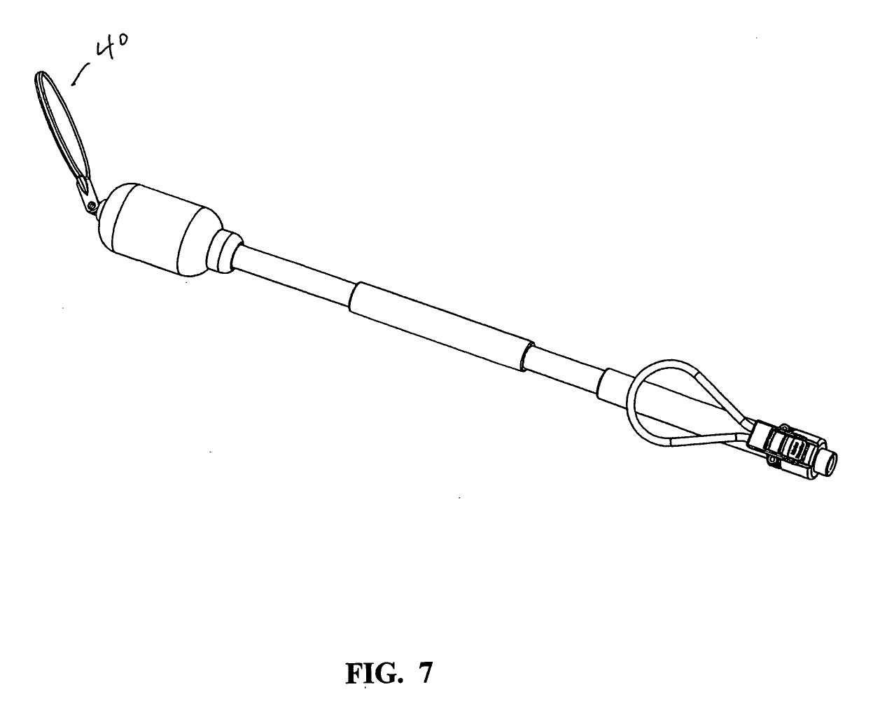

Referring still to FIGS. 5 and 6, the attachable mirror device is preferably hingedly coupled to the base 41 via a moveable stem/swivel 42. This stem/swivel 42 allows the double sided mirror 44 to be rotated 180 degrees about an axis plane parallel to the rod when the double sided mirror is attached to the device. FIG. 7 illustrates a perspective view of the present invention when the mirror device is attached to the distal end.

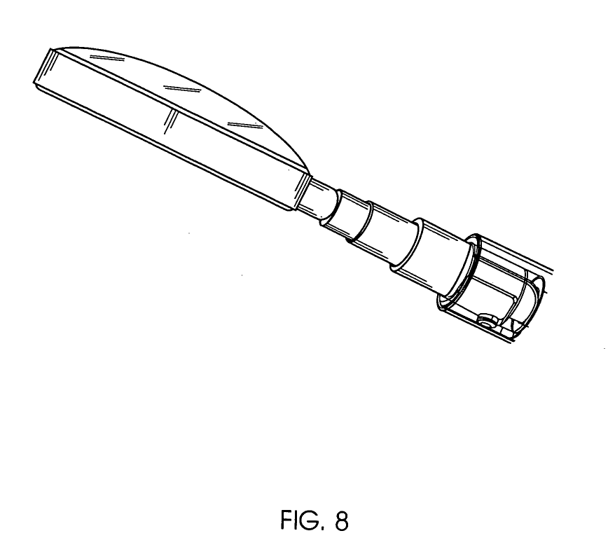

In another embodiment, the mirror device may be two-sided. FIG. 8 illustrates a two sided mirror device for removably coupling to the distal end of the rod of the present invention. In such an embodiment, the two sided mirror preferably has a convex side 71 and a flat side 72. The convex side 71 provides better visibility when assessing the perimeters for unsafe conditions, while the flat-side 72 of the mirror allows the field worker/user of the device to locate and read the dial index on a meter. The two sided mirror device also includes a telescoping base 73 which provides increased space between the field worker/user and any dangerous conditions as he/she attempts to enter onto a property. As explained earlier herein, when the mirror is attached to the tool, individuals can use the body length, along with their arm's reach, to get better visibility while maintaining a safer distance from hazardous conditions when they are trying to gain access into a property or when trying to read a meter dial index according to the present invention. Safer access can be obtained with the increased distance between the field worker and the gate, wall or partition.

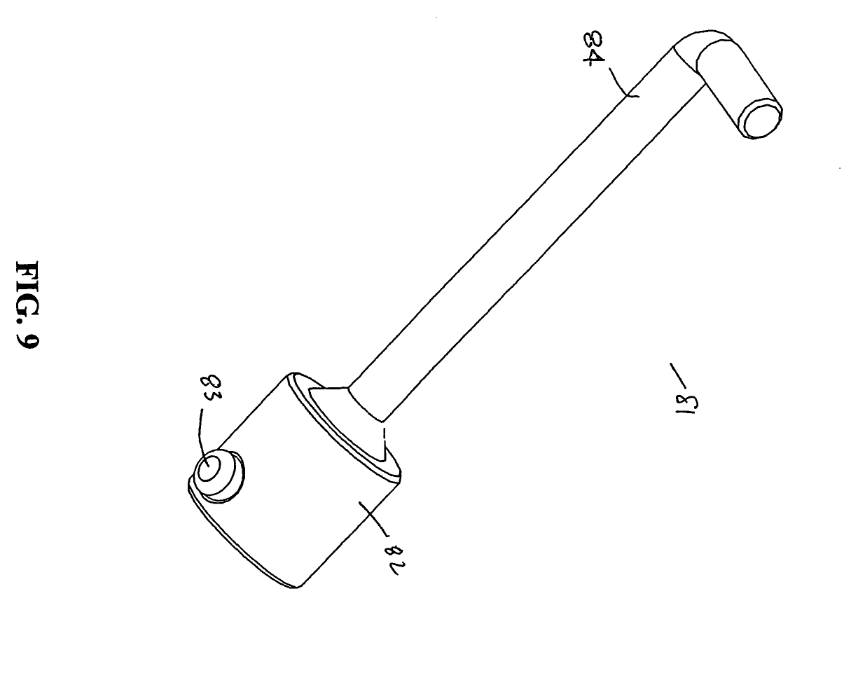

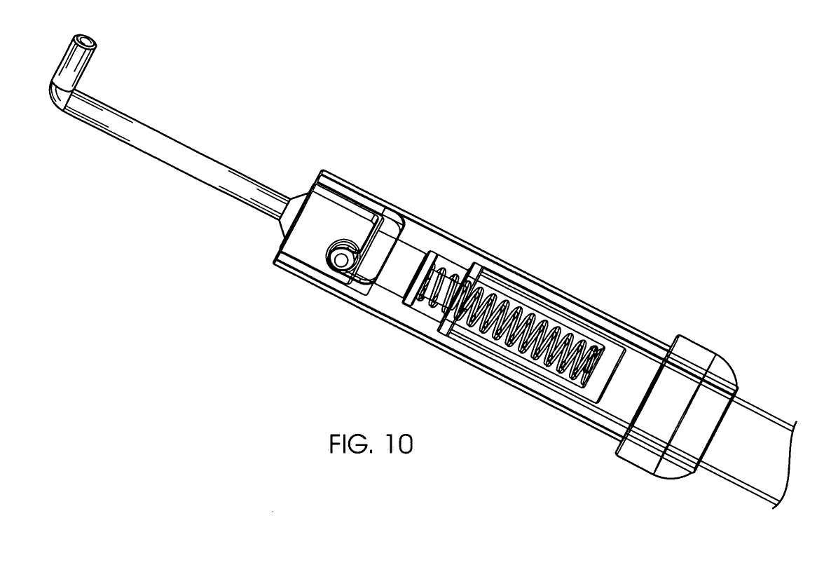

As explained earlier herein, additional mechanisms/devices may be coupled to the distal end of the rod in order to add increased functionality. FIG. 9 illustrates a removeably attachable hook/latch device 81 for use with the present invention; while FIG. 10 illustrates a close-up break-out view of the removeably attachable hook/latch device 81 when attached to the distal end of the present invention. As shown in these two figures, the hook/latch device 81 includes a base 82 having a locking bump 83 positioned on one side of the base. When the base 82 is inserted into the open, distal end of the rod, the locking bump 83 is placed into the “J” shaped catch. The compression spring and pressure point force the base outward, securing the locking bump within the “J” shaped catch such that the hook/latch device can be attached to the distal end of the rod in order to provide individuals with increase functionality. More specifically, when the hook/latch device is attached to the tool, individuals can use the hook/latch to open meter lids from over a fence, gate or retaining wall, all at a safer distance from hazardous conditions.

Referring still to FIGS. 9 and 10, the attachable hook/latch device includes a metallic hook/latch 84 extending outwardly from the base 82. This hook/latch 84 allows the meter reader to use the device to unhook and open a closed meter life from a distance behind a locked gate, fence or retaining wall. It also provides increased space between the field worker/user and any dangerous conditions which may be behind such fence, gate or wall as he/she attempts read meters.

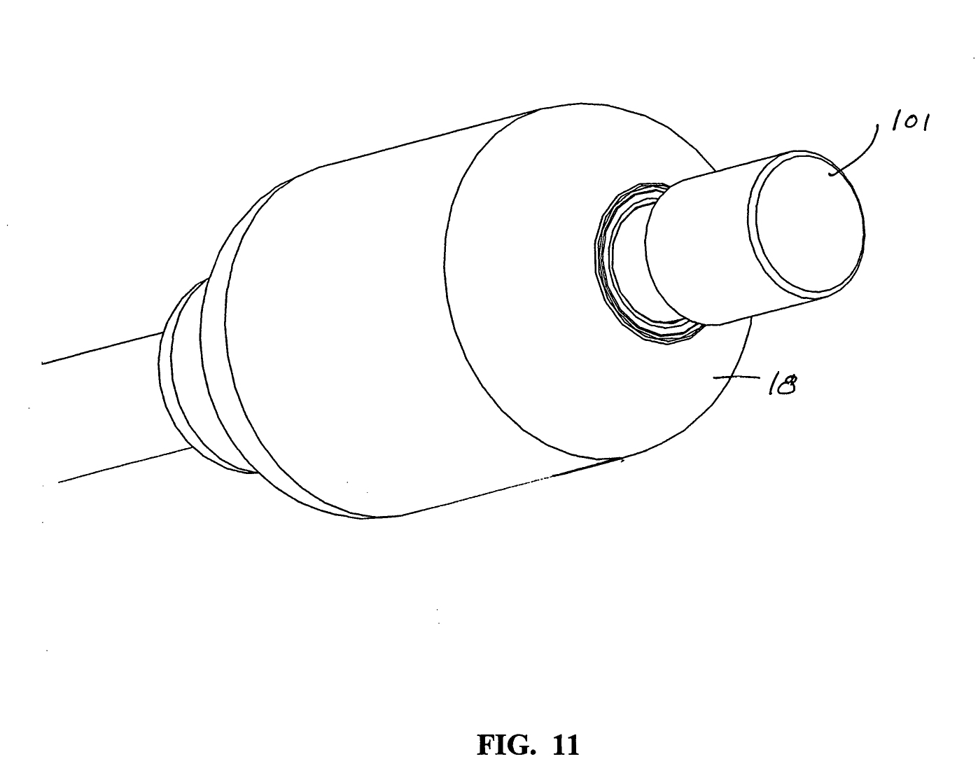

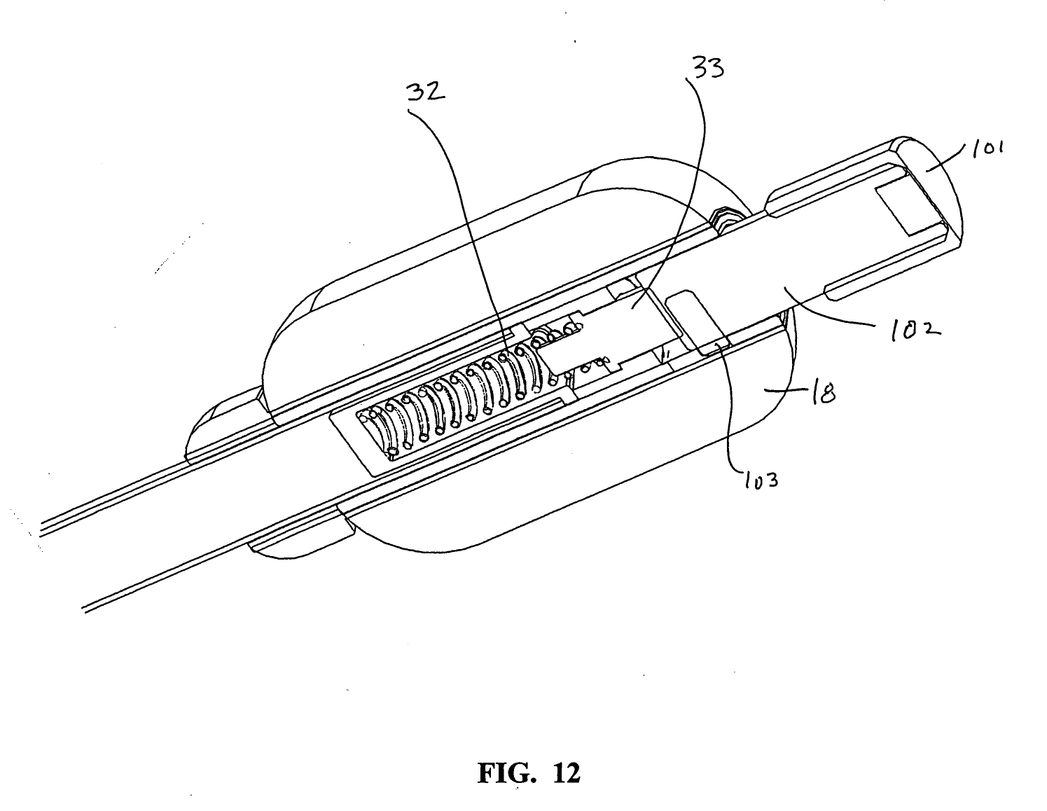

As explained earlier herein, additional mechanisms/devices may be coupled to the distal end of the rod in order to add increased functionality. FIG. 11 illustrates a removeably attachable end magnet for use with the present invention; while FIG. 12 illustrates a close-up cross-sectional view of the removeably attachable end magnet 101 when attached to the distal end of the present invention. As shown in these two figures, the end magnet 101 is preferably cylindrical in shape, having a circumference about the same as the actual rod itself. As with the other attachable items, the end magnet includes a base 102 having a locking bump 103 positioned on one side of the base. As shown in FIG. 12, when the base 102 is inserted into the distal end of the rod, the locking bump 103 is placed into the “J” shaped catch. The compression spring and pressure point force the base outward, securing the locking bump within the “J” shaped catch such that the end magnet can be attached to the distal end of the rod in order to provide individuals with increase functionality. More specifically, when the end magnet 101 is attached to the tool, individuals can use the magnet to magnetize any metal lids which may cover the meter and then easily open the lid, all while maintaining a safer distance from any potentially hazardous conditions and/or obtaining access over any locked gate or fence without having to scale the same.

It is further intended that any other embodiments of the present invention that result from any changes in application or method of use or operation, method of manufacture, shape, size, or material which are not specified within the written description or illustrations contained herein yet are considered apparent or obvious to one skilled in the art are within the scope of the present invention.

1. A Curb Meter Tool/Dog Stick device for use by field workers/meter readers, said device comprising:
a central rod shaped body having a handle end and a distal end; and
a mirror device removeably coupled to said central rod shaped body at said distal end; and
a cleaning ball positioned circumferentially about the central rod shaped body closer to said distal end of the central rod shaped body.

2. The Curb Meter Tool/Dog Stick device of claim 1 further comprising a recess in the handle end for housing a small bottle of water or other liquid/fluid.

3. The Curb Meter Tool/Dog Stick device of claim 1, wherein the mirror device is double sided.

4. The Curb Meter Tool/Dog Stick device of claim 1, wherein the mirror is removeably coupled to said central rod shaped body via a locking mechanism including a “J” shaped latch and a locking bump.

5. The Curb Meter Tool/Dog Stick device of claim 1, wherein the mirror device is removed and replaced by a latch/hook device having a hook for opening up meter covers.

6. The Curb Meter Tool/Dog Stick device of claim 1, wherein the mirror device is removed and replaced by an end magnet for magnetizing and opening up metallic meter covers.

7. The Curb Meter Tool/Dog Stick device of claim 3, wherein the double-sided mirror includes:
a base;
a swivel/stem for rotating the mirror at different angles and thereby allowing field workers/meter readers to locate meters from above, below and around gates, walls or partitions for safe and easy reading of the dial index; and
a two sided mirror coupled to said stem, one side being flat and other side being convex.

8. A Curb Meter Tool/Dog Stick device for use by field workers/meter readers, said device comprising:
a central rod shaped body having a hollow interior, a handle end and a distal end;
a mirror device removeably coupled to said central rod shaped body at said distal end; and
a cleaning ball positioned circumferentially about the central rod shaped body, closer to said distal end of the central rod shaped body, said cleaning ball preferably made of sponge-like material.

9. The Curb Meter Tool/Dog Stick device of claim 8 further comprising a recess in the handle end for housing a small bottle of water or other liquid/fluid.

10. The Curb Meter Tool/Dog Stick device of claim 8, further comprising:
a cylindrical rawhide ball disposed circumferentially about the central rod shaped body, within the cleaning ball, in order to provide support to the cleaning ball, thereby encouraging dogs to bite on the cleaning ball rather than attacking the person holding the device.

11. The Curb Meter Tool/Dog Stick device of claim 8, wherein the mirror device is double sided.

12. The Curb Meter Tool/Dog Stick device of claim 8, wherein the mirror is removeably coupled to said central rod shaped body via a locking mechanism including a “J” shaped latch and a locking bump.

13. The Curb Meter Tool/Dog Stick device of claim 8, wherein the mirror device is removed and replaced by a latch/hook device having a hook for opening up meter covers.

14. The Curb Meter Tool/Dog Stick device of claim 8, wherein the mirror device is removed and replaced by an end magnet for magnetizing and opening up metallic meter covers.

15. The Curb Meter Tool/Dog Stick device of claim 11, wherein the double-sided mirror includes:
a base;
a swivel/stem for rotating the mirror at different angles and thereby allowing field workers/meter readers to locate meters from above, below and around gates, walls or partitions for safe and easy reading of the dial index; and
a two sided mirror coupled to said stem, one side being flat and other side being convex.

16. A Curb Meter Tool/Dog Stick device for use by field workers/meter readers, said device comprising:
a central rod shaped body having a handle end and a distal end;
a latch/hook removeably coupled to said central rod shaped body at said distal end; and
a cleaning ball positioned circumferentially about the central rod shaped body, closer to said distal end of the central rod shaped body, said cleaning ball preferably made of sponge-like material.

17. The Curb Meter Tool/Dog Stick device of claim 16, wherein the latch/hook is removeably coupled to said central rod shaped body via a locking mechanism.

18. The Curb Meter Tool/Dog Stick device of claim 16, wherein the latch/hook includes:
a base having a locking bump; and
a hook coupled to said base.

19. (canceled)

20. The Curb Meter Tool/Dog Stick device of claim 16, further comprising:
a cylindrical rawhide ball disposed circumferentially about the central rod shaped body, within the cleaning ball in order to provide support to the cleaning ball, thereby encouraging dogs to bite on the cleaning ball rather than attacking the person holding the device.

21. A Curb Meter Tool/Dog Stick device for use by field workers/meter readers, said device comprising:
a central rod shaped body having a handle end and a distal end;
an end magnet removeably coupled to said central rod shaped body at said second distal end; and
a cleaning ball positioned circumferentially about the central rod shaped body, closer to said distal end of the central rod shaped body, said cleaning ball preferably made of sponge-like material.

22. The Curb Meter Tool/Dog Stick device of claim 21, wherein the end magnet is removeably coupled to said central rod shaped body via a locking mechanism.

23. The Curb Meter Tool/Dog Stick device of claim 21, wherein the end magnet includes:
a base having a locking bump; and
a cylindrically shaped magnet coupled to said base.

24. (canceled)

25. The Curb Meter Tool/Dog Stick device of claim 21 further comprising:
a cylindrical rawhide ball disposed circumferentially about the central rod shaped body, within the cleaning ball in order to provide support to the cleaning ball, thereby encouraging dogs to bite on the cleaning ball rather than attacking the person holding the device.
